(19) United States
(12) Patent Application Publication
(10) Pub. No.: US 2008/0018384 A1
(43) Pub. Date: Jan. 24, 2008

(54) Internal voltage generating apparatus and method for semiconductor integrated circuit

(75) Inventors: Myung Jin Kim, Gyeonggi-do (KR); Yong Bok An, Gyeonggi-do (KR)

Correspondence Address: VENABLE LLP, P.O. BOX 34385, WASHINGTON, DC, 20043-9998, US

(73) Assignee: Hynix Semiconductor Inc., Gyeonggi-do (KR)

(21) Appl. No.: 11/819,422

(22) Filed: Jun. 27, 2007

(30) Foreign Application Priority Data
Jul. 20, 2006 (KR) 10-2006-0067786

(51) Int. Cl. G05F 1/10

(52) U.S. Cl. 327/536

(57) ABSTRACT

An internal voltage generating apparatus for a semiconductor integrated circuit includes a detecting circuit configured to detect levels of a plurality of internal voltages, to generate a plurality of voltage enable signals and a pump enable signal. A pump circuit performs a voltage pumping operation in response to the pump enable signal and outputs the plurality of internal voltages in response to the plurality of voltage enable signals.

### CROSS-REFERENCE TO RELATED PATENT APPLICATION

This application claims the benefit of Korean Patent Application No. 10-2006-0067786, filed on Jul. 20, 2006, in the Korean Intellectual Property Office, the disclosure of which is incorporated herein in its entirety by reference.

### BACKGROUND OF THE INVENTION

1. Technical Field

The present invention relates to an internal voltage generating apparatus and method for a semiconductor integrated circuit. In particular, the present invention relates to an internal voltage generating apparatus and method for a semiconductor integrated circuit that increases an area margin.

2. Related Art

In general, each of semiconductor integrated circuits is supplied with voltages including an external power supply voltage VDD and a ground voltage VSS from the outside of a chip so as to generate internal voltages, such as a bootstrapping voltage VPP and a bulk voltage VBB. A semiconductor integrated circuit sets a target level for each of the internal voltages and detects a current level of the generated internal voltage. When the current level of the internal voltage is lower than (or higher than) the target level, the semiconductor integrated circuit pumps the internal voltage, such that it makes the level of internal voltage level equal with target level. For generating an internal voltage, the semiconductor integrated circuit includes a voltage detector, a pulse generator, and a voltage pump, which are essential for generating a voltage having a level higher than an external power supply voltage, such as the bootstrapping voltage, or a voltage having a level lower than a ground voltage, such as the bulk voltage.

As the degree of integration of the semiconductor integrated circuit is improved, it is required to densely dispose elements in each region of the semiconductor integrated circuit while increasing an area margin of an internal voltage generating apparatus for the semiconductor integrated circuit. However, the conventional internal voltage generating apparatus for the semiconductor integrated circuit all must include a voltage detector, a pulse generator, and a voltage pump. Thus, diminishing the area of the internal voltage generating apparatus is limited. Therefore, it is difficult to increase an area margin.

### SUMMARY OF THE INVENTION

Embodiments of the present invention provide an internal voltage generating apparatus and method for a semiconductor integrated circuit that increase an area margin.

An embodiment of the present invention provides an internal voltage generating apparatus for a semiconductor integrated circuit including: a detecting circuit configured to detect levels of a plurality of internal voltages, to generate a plurality of voltage enable signals and a pump enable signal; and a pump circuit configured to perform a voltage pumping operation in response to the pump enable signal and to output the plurality of internal voltages in response to the plurality of voltage enable signals.

Another embodiment of the present invention provides an internal voltage generating apparatus for a semiconductor integrated circuit including: a first voltage detecting unit configured to detect whether a first internal voltage exceeds a first reference level and output a first voltage enable signal; a second voltage detecting unit configured to detect whether a second internal voltage exceeds a second reference level and output a second voltage enable signal; a signal combining unit configured to make a voltage pump operate when at least one of the first voltage enable signal and the second voltage enable signal is enabled; and a voltage output unit configured to output a pumping voltage output from the voltage pump as the first internal voltage or the second internal voltage in response to whether the first voltage enable signal or the second voltage enable signal has been enabled or not.

Still another embodiment of the present invention provides an internal voltage generating method for a semiconductor integrated circuit including: detecting whether each of a plurality of internal voltages exceeds a corresponding reference level and outputting a plurality of voltage enable signals; generating a pump enable signal in response to the plurality of voltage enable signals; performing a voltage pumping operation in response to the pump enable signal so as to generate a pumping voltage; and receiving the pumping voltage and outputting the plurality of internal voltages corresponding to the plurality of voltage enable signals, respectively.

### BRIEF DESCRIPTION OF THE DRAWINGS

FIG. 1 is a block diagram illustrating a structure of an internal voltage generating apparatus for a semiconductor integrated circuit according to an embodiment of the present invention.

FIG. 2A is a diagram illustrating an example of a structure of a first voltage detecting unit shown in FIG. 1.

FIG. 2B is a diagram illustrating an example of a structure of a second voltage detecting unit shown in FIG. 1.

FIG. 3A is a diagram illustrating another example of a structure of the first voltage detecting unit shown in FIG. 1.

FIG. 3B is a diagram illustrating another example of a structure of the second voltage detecting unit shown in FIG. 1.

FIG. 4 is a diagram illustrating a structure of a signal combining unit shown in FIG. 1.

FIG. 5 is a diagram illustrating a structure of a voltage output unit shown in FIG. 1.

### DESCRIPTION OF EXEMPLARY EMBODIMENT

Embodiments of the present invention will now be described in detail with reference to the accompanying drawings.

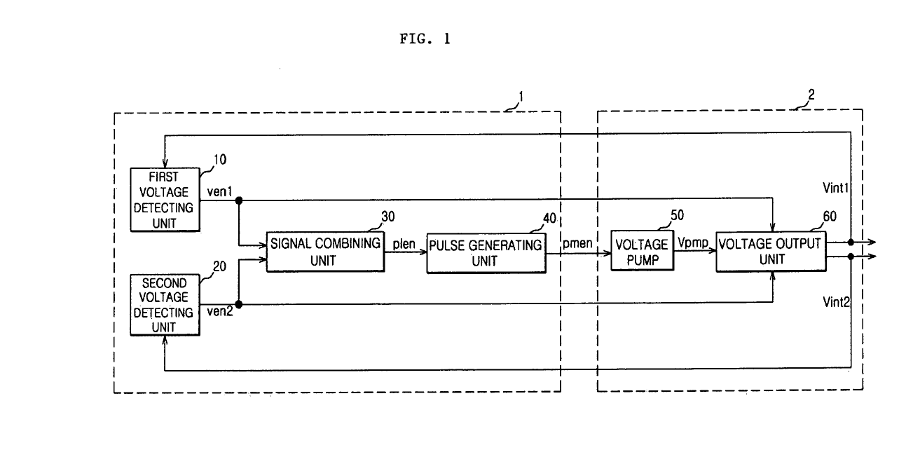

FIG. 1 is a block diagram illustrating a structure of an internal voltage generating apparatus for a semiconductor integrated circuit according to an embodiment of the present invention. In FIG. 1, there is shown a case in which two internal voltages are generated by one internal voltage generating apparatus. However, the present invention is not limited to the case shown in FIG. 1. An internal voltage generating apparatus may include one voltage pump and may be able to generate three or more internal voltages.

As shown in FIG. 1, an internal voltage generating apparatus for a semiconductor integrated circuit according to an embodiment of the present invention includes a first voltage detecting unit 10, a second voltage detecting unit 20, a signal combining unit 30, a pulse generating unit 40, a voltage pump 50, and a voltage output unit 60.

The first voltage detecting unit 10, the second voltage detecting unit 20, the signal combining unit 30, and the pulse generating unit 40 are referred to as a detecting circuit 1, and the voltage pump 50 and the voltage output unit 60 are referred to as a pump circuit 2.

If a first internal voltage Vint1 is a bootstrapping voltage VPP, a second internal voltage Vint2 has a level higher than that of the bootstrapping voltage VPP. The voltage pump 50 performs a pumping operation to increase a voltage level, and accordingly, a pumping voltage Vpmp has a level higher than that of an external power supply voltage VDD.

Meanwhile, if the first internal voltage Vint1 is a bulk voltage VBB, the second internal voltage Vint2 has a level lower than that of the bulk voltage VBB. The voltage pump 50 performs a pumping operation to decrease a voltage level, and accordingly, the pump voltage Vpmp has a level lower than that of a ground voltage VSS.

The following description will be made based on the assumption that the first internal voltage Vint1 is the bulk voltage.

The first voltage detecting unit 10 detects whether the level of the first internal voltage Vint1 exceeds a first reference level and outputs a first voltage enable signal ven1 according to detecting result of the first internal voltage Vint1. When detecting that the level of the first internal voltage Vint1 exceeds the first reference level, the first voltage detecting unit 10 enables the first voltage enable signal ven1. When detecting that the potential level of the first internal voltage Vint1 is lower than the first reference level, the first internal detecting unit 10 disables the first voltage enable signal ven1.

The second voltage detecting unit 20 detects whether the level of the second internal voltage Vint2 exceeds a second reference level and outputs a second voltage enable signal ven2 according to detecting result of the second internal voltage Vint2. When detecting that the level of the second internal voltage Vint2 exceeds the second reference level, the second voltage detecting unit 20 enables the second voltage enable signal ven2. When detecting that the level of the second internal voltage Vint2 is lower than the second reference level, the second voltage detecting unit 20 disables the second voltage enable signal ven2.

Here, the first reference level is higher than the second reference level.

The signal combining unit 30 combines the first and second voltage enable signals ven1 and ven2 and outputs the combined result as a pulse enable signal plen. When at least one of the first voltage enable signal ven1 and the second voltage enable signal ven2 is enabled, the signal combining unit 30 enables the pulse enable signal plen. The reason why is when at least one of the first voltage enable signal ven1 and the second voltage enable signal ven2 is enabled, then at least one of the first internal voltage Vint1 and the second internal voltage Vint2 exceeds the corresponding reference level, and thus it is required to operate the voltage pump 50.

When both of the first voltage enable signal ven1 and the second voltage enable signal ven2 are disabled, that is, when the first internal voltage Vint1 has a level, lower than the first reference level and the second internal voltage Vint2 has a level lower than the second reference level, the signal combining unit 30 disables the pulse enable signal plen.

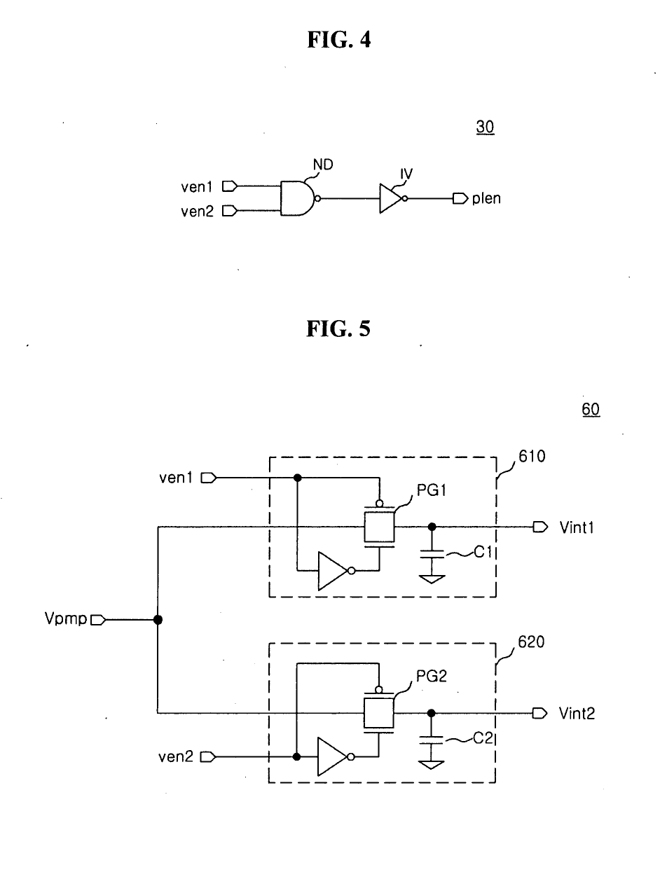

When the first voltage enable signal ven1 and the second voltage enable signal ven2 are low enable signals, referring to FIG. 4, the signal combining unit 30 may be composed of a combination of a NAND gate ND and an inverter IV.

The pulse generating unit 40 generates a pump enable signal pmen in response to the pulse enable signal plen. When the pulse enable signal plen is enabled, the pulse generating unit 40 enables the pump enable signal pmen. In contrast, when the pulse enable signal plen is disabled, the pulse generating unit 40 disables the pump enable signal pmen.

The voltage pump 50 performs a voltage pumping operation to generate a pumping voltage Vpmp in response to the pump enable signal pmen. When the pump enable signal pmen is enabled, the voltage pump 50 performs the pumping operation, and when the pump enable signal pmen is disabled, the voltage pump 50 stops the pumping operation.

The voltage output unit 60 receives the pumping voltage Vpmp and outputs the first and second internal voltages Vint1 and Vint2, in response to the first and second voltage enable signals ven1 and ven2. When the first voltage enable signal ven1 is enabled, the voltage output unit 60 outputs the pumping voltage Vpmp as the first internal voltage Vint1. In contrast, when the first internal voltage Vint1 has a level lower than the first reference level, the first voltage enable signal ven1 is disabled, and then the voltage output unit 60 does not output the pumping voltage Vpmp. Therefore, in this case, the first internal voltage Vint1 is not influenced by the pumping voltage Vpmp. Then, the first voltage detecting unit 10 detects the first internal voltage Vint1 to control whether to enable or disable the first voltage enable signal ven1. Therefore, the first internal voltage Vint1 is maintained at the first reference level.

When the second voltage enable signal ven2 is enabled, the voltage output unit 60 outputs the pumping voltage Vpmp as the second internal voltage Vint2. In contrast, when the second internal voltage Vint2 has a level lower than the second reference level, the second voltage enable signal ven2 is disabled, and then the voltage output unit 60 does not output the pumping voltage Vpmp. Therefore, in this case, the second internal voltage Vint2 is not influenced by the pumping voltage Vpmp. Then, the second voltage detecting unit 20 detects the second internal voltage Vint2 and controls whether to enable or disable the second voltage enable signal ven2. Therefore, the second internal voltage Vint2 is maintained at the second reference level.

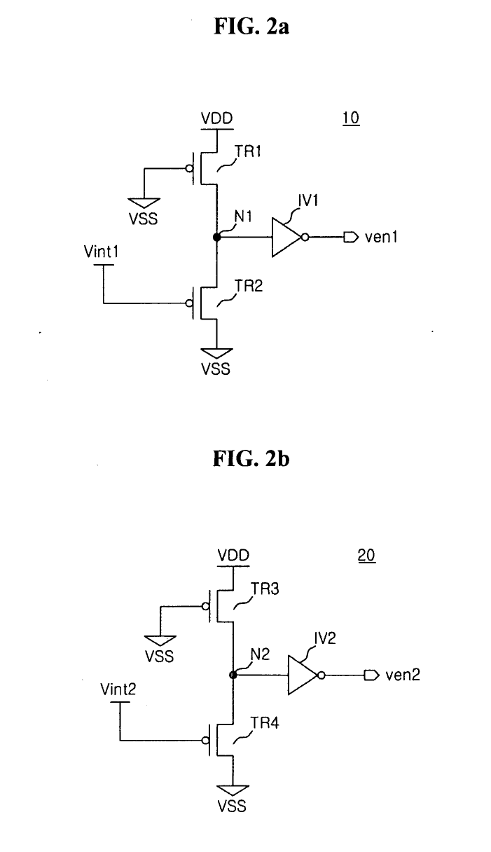

FIG. 2A is a diagram illustrating an example of a structure of a first voltage detecting unit shown in FIG. 1. FIG. 2B is a diagram illustrating an example of a structure of a second voltage detecting unit shown in FIG. 1. FIGS. 2A and 2B show the first and second voltage detecting units when the first internal voltage is the bulk voltage.

The first voltage detecting unit 10 includes: a first transistor TR1 having a gate terminal to which the ground voltage VSS is applied, a source terminal to which the external power supply voltage VDD is applied, and a drain terminal coupled with a first node N1; a second transistor TR2 having a gate germinal to which the first internal voltage Vint1 is applied and a source terminal coupled with the first node N1, and a drain terminal grounded; and a first inverter IV1 receiving a signal formed at the first node N1 and outputting the first voltage enable signal ven1.

Here, the second transistor TR2 is a PMOS transistor. Therefore, when the level of the first internal voltage Vint1 exceeds the first reference level, the second transistor TR2 is turned off and thus the first voltage enable signal ven1 becomes a low level. Meanwhile, when the level of the first internal voltage Vint1 is lower than the first reference level, the second transistor TR2 is turned on and the first voltage enable signal ven1 is disabled.

The second voltage detecting unit 20 includes: a third transistor TR3 having a gate terminal to which the ground voltage VSS is applied, a source terminal to which the external power supply voltage VDD is applied, and a drain terminal coupled with a second node N2; a fourth transistor TR4 having a gate terminal to which the second internal voltage Vint2 is applied, a source terminal coupled with the second node N2, and a drain terminal grounded; and a second inverter IV2 receiving a signal formed at the second node N2 and outputting the second voltage enable signal ven2.

Here, the fourth transistor TR4 is a PMOS transistor. Therefore, when the level of the second internal voltage Vint2 exceeds the second reference level, the fourth transistor TR4 is turned off and thus the second voltage enable signal ven2 becomes a low level. Meanwhile, when the level of the second internal voltage Vint2 is lower than the second reference level, the fourth transistor TR4 is turned on, and the second voltage enable signal ven2 is disabled.

In this case, since the first reference level is higher than the second reference level, the threshold voltage of the second transistor TR2 of the first voltage detecting unit 10 should be smaller than the threshold voltage of the fourth transistor TR4 of the second voltage detecting unit 20. For this, the sizes of the second and fourth transistors TR2 and TR4 are adjusted. The fourth transistor TR4 is turned on corresponding to a gate voltage having a lower level than that of the second transistor TR2. The first and second reference levels are defined according to the gate voltages when the second and fourth transistors TR2 and TR4 are turned on.

Then, when the first voltage enable signal ven1 or the second voltage enable signal ven2 is enabled, the pulse enable signal plen to be output from the signal combining unit 30 is enabled. Accordingly, the pump enable signal pmen to be output from the pulse generating unit 40 is enabled and thus the voltage pump 50 generates the pumping voltage Vpmp.

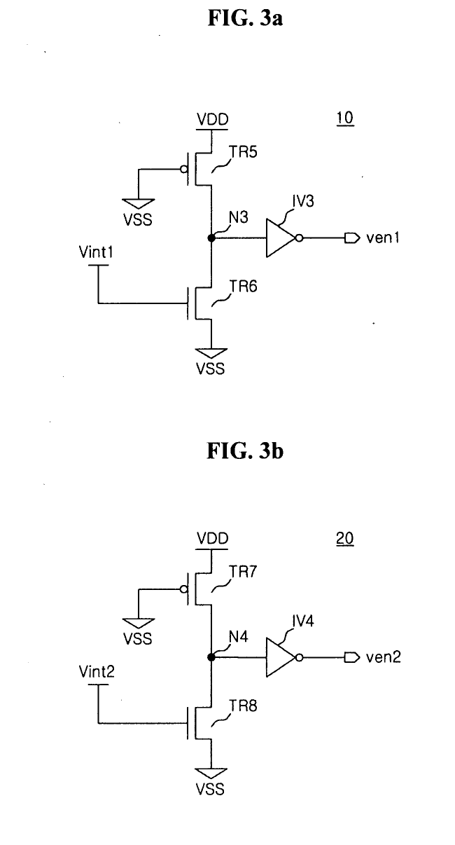

FIG. 3A is a diagram illustrating another example of a structure of the first voltage detecting unit shown in FIG. 1. FIG. 3B is a diagram illustrating another example of a structure of the second voltage detecting unit shown in FIG. 1. FIGS. 3A and 3B show the first and second voltage detecting units when the first internal voltage is the bootstrapping voltage.

The first voltage detecting unit 10 includes: a fifth transistor TR5 having a gate terminal to which the ground voltage VSS is applied, a source terminal to which the external power supply voltage VDD is applied, and a drain terminal coupled with a third node N3; a sixth transistor TR6 having a gate germinal to which the first internal voltage Vint1 is applied, a source terminal coupled with the third node N3, and a drain terminal grounded; and a third inverter IV3 receiving a signal formed at the third node N3 and outputting the first voltage enable signal ven1.

Here, the sixth transistor TR6 is an NMOS transistor. Therefore, when the level of the first internal voltage Vint1 exceeds the first reference level, the sixth transistor TR6 is turned on and thus the first voltage enable signal ven1 becomes a high level. Meanwhile, when the level of the first internal voltage Vint1 is lower than the first reference level, the sixth transistor TR6 is turned off and thus the first voltage enable signal ven1 is enabled.

The second voltage detecting unit 20 includes: a seventh transistor TR7 having a gate terminal to which the ground voltage VSS is applied, a source terminal to which the external power supply voltage VDD is applied, and a drain terminal coupled with a fourth node N4; an eighth transistor TR8 having a gate terminal to which the second internal voltage Vint2 is applied, a source terminal coupled with the fourth node N4, and a drain terminal grounded; and a fourth inverter IV4 receiving a signal formed at the fourth node N4 and outputting the second voltage enable signal ven2.

Here, the eighth transistor TR8 is an NMOS transistor. Therefore, when the level of the second internal voltage Vint2 exceeds the second reference level, the eighth transistor TR8 is turned on and thus the second voltage enable signal ven2 becomes a high level. Meanwhile, when the level of the second internal voltage Vint2 is lower than the second reference level, the eighth transistor TR8 is turned off and thus the second voltage enable signal ven2 is enabled.

In this case, since the first reference level is lower than the second reference level, the threshold voltage of the sixth transistor TR6 of the first voltage detecting unit 10 should be smaller than the threshold voltage of the eighth transistor TR8 of the second voltage detecting unit 20. For this, the sizes of the sixth and eighth transistors TR6 and TR8 are adjusted. The sixth transistor TR6 is turned on corresponding to a gate voltage having a lower level than that of the eighth transistor TR8. The first and second reference levels are defined according to the gate voltages when the sixth and eighth transistors TR6 and TR8 are turned on.

Then, when the first voltage enable signal ven1 or the second voltage enable signal ven2 is enabled, the pulse enable signal plen to be output from the signal combining unit 30 is enabled. Accordingly, the pump enable signal pmen to be output from the pulse generating unit 40 is enabled and thus the voltage pump 50 generates the pumping voltage Vpmp.

FIG. 5 is a diagram illustrating a structure of a voltage output unit shown in FIG. 1.

As shown in FIG. 5, the voltage output unit 60 includes a first output section 610 outputting the pumping voltage Vpmp as the first internal voltage Vint1 in response to the first voltage enable signal ven1; and a second output unit 620 outputting the pumping voltage Vpmp as the second internal voltage Vint2 in response to the second voltage enable signal ven2.

The first output section 610 includes a first pass gate PG1 that is turned on when the first voltage enable signal ven1 is enabled; and a first capacitor C1 that stores a voltage output from the first pass gate PG1.

The second output section 620 includes a second pass gate PG2 that is turned on when the second voltage enable signal ven2 is enabled; and a second capacitor C2 that stores a voltage output from the second pass gate PG2.

As described above, when the first internal voltage Vint1 is the bulk voltage, if the first internal voltage Vint1 exceeds the first reference level, the first voltage enable signal ven1 is enabled. If the second internal voltage Vint2 exceeds the second reference level, the second voltage enable signal ven2 is enabled. If the first voltage enable signal ven1 or the second voltage enable signal is enabled, the voltage pump 50 operates to generate the pumping voltage Vpmp. Then, if the first internal voltage Vint1 exceeds the first reference voltage, the first voltage enable signal ven1 is enabled and thus the pumping voltage Vpmp is output as the first internal voltage Vint1. If the second internal voltage Vint2 exceeds the second reference voltage, the second voltage enable signal ven2 is enabled and thus the pumping voltage Vpmp is output as the second internal voltage Vint2.

When the first internal voltage Vint1 is the bootstrapping voltage, if the first internal voltage Vint1 is lower than the first reference level, the first voltage enable signal ven1 is enabled. If the second internal voltage Vint2 is lower than the second reference level, the second voltage enable signal ven2 is enabled. If the first voltage enable signal ven1 or the second voltage enable signal ven2 is enabled, the voltage pump 50 operates to generate the pumping voltage Vpmp. Then, if the first internal voltage Vint1 is lower than the first reference level, the first voltage enable signal ven1 is enabled and thus the pumping voltage Vpmp is output as the first internal voltage Vint1. If the second internal voltage Vint2 is lower than the second reference level, the second voltage enable signal ven2 is enabled, and the pumping voltage Vpmp is output as the second internal voltage Vint2.

According to the present invention, a plurality of internal voltages are generated by means of using an internal voltage generating apparatus having a voltage pump. Accordingly, an area margin in a semiconductor integrated circuit increases, as compared to the related art. Therefore, it is possible to improve the degree of integration of a semiconductor integrated circuit and the efficiency of power usage increases.

It will be apparent to those skilled in the art that various modifications and changes may be made without departing from the scope and spirit of the present invention. Therefore, it should be understood that the above embodiments are not limitative, but illustrative in all aspects. The scope of the present invention is defined by the appended claims rather than by the description preceding them, and therefore all changes and modifications that fall within metes and bounds of the claims, or equivalents of such metes and bounds are therefore intended to be embraced by the claims.

The above-mentioned internal voltage generating apparatus and method for the semiconductor integrated circuit of an embodiment of the present invention generate a plurality of internal voltages having each reference level by using one voltage pump. Therefore, it is possible to improve an area margin and to improve the efficiency of power usage.

What is claimed is:

1. An internal voltage generating apparatus for a semiconductor integrated circuit, the apparatus comprising:
a detecting circuit configured to detect levels of a plurality of internal voltages, to generate a plurality of voltage enable signals and a pump enable signal; and
a pump circuit configured to perform a voltage pumping operation in response to the pump enable signal and to output the plurality of internal voltages in response to the plurality of voltage enable signals.

2. The internal voltage generating apparatus of claim 1,
wherein the detecting circuit is configured to compare each of the plurality of internal voltages with each of a plurality of reference levels, thereby generating the plurality of voltage enable signals and the pump enable signal.

3. The internal voltage generating apparatus of claim 1,
wherein the detecting circuit comprises:
a plurality of voltage detecting units configured to respectively receive a corresponding internal voltage of the plurality of internal voltages, to output a corresponding voltage enable signal of the plurality of voltage enable signals;
a signal combining unit configured to combine the plurality of voltage enable signals to output a pulse enable signal; and
a pulse generating unit configured to generate a pump enable signal in response to the pulse enable signal.

4. The internal voltage generating apparatus of claim 1,
wherein the plurality of internal voltages comprises a first internal voltage and a second internal voltage;
the plurality of voltage detecting units comprises a first voltage detecting unit and a second voltage detecting unit;
the plurality of voltage enable signals comprise a first voltage enable signal and a second voltage enable signal;
the first voltage detecting unit generates the first voltage enable signal according to comparing result between a level of the first internal voltage and a first reference level; and
the second voltage detecting unit generates the second voltage enable signal according to comparing result between a level of the second internal voltage and a second reference level.

5. The internal voltage generating apparatus of claim 4,
wherein the first voltage detecting unit comprises:
a first transistor having a gate terminal receiving a ground voltage, a source terminal applied an external power supply voltage, and a drain terminal coupled with a first node;
a second transistor having a gate terminal receiving the first internal voltage, a source terminal coupled with the first node, and a drain terminal that is grounded; and
an inverter configured to receive a signal formed at the first node and output the first voltage enable signal.

6. The internal voltage generating apparatus of claim 5,
wherein the second voltage detecting unit comprises:
a third transistor having a gate terminal receiving the ground voltage, a source terminal receiving the external power supply voltage, and a drain terminal coupled with a second node;
a fourth transistor having a gate terminal receiving the second internal voltage, a source terminal coupled with the second node, and a drain terminal that is grounded; and
an inverter configured to receive a signal formed at the second node and output the second voltage enable signal.

7. The internal voltage generating apparatus of claim 6,
wherein the second transistor and the fourth transistor are PMOS transistors, and
a threshold voltage of the second transistor is different from a threshold voltage of the fourth transistor.

8. The internal voltage generating apparatus of claim 4,
wherein, when at least one of the first voltage enable signal and the second voltage enable signal is enabled, the signal combining unit enables the pulse enable signal.

9. The internal voltage generating apparatus of claim 8,
wherein the signal combining unit is composed of a NAND gate receiving the first voltage enable signal and the second voltage enable signal and an inverter.

10. The internal voltage generating apparatus of claim 4,
wherein the first internal voltage is a bulk voltage; and
the second internal voltage is a voltage having a level lower than that of the bulk voltage.

11. The internal voltage generating apparatus of claim 4,
wherein the first internal voltage is a bootstrapping voltage; and
the second internal voltage is a voltage having a level higher than that of the bootstrapping voltage.

12. The internal voltage generating apparatus of claim 1,
wherein the pump circuit comprises:
a voltage pump configured to perform a voltage pumping operation in response to the pump enable signal to generate a pumping voltage, and
a voltage output unit configured to receive the pumping voltage, thereby outputting the plurality of internal voltages corresponding to the plurality of voltage enable signals, respectively.

13. The internal voltage generating apparatus of claim 12,
wherein the plurality of internal voltages comprise a first internal voltage and a second internal voltage;
the plurality of voltage enable signals comprise a first voltage enable signal and a second voltage enable signal;
when the first voltage enable signal is enabled, the voltage output unit outputs the pumping voltage as the first internal voltage; and
when the second voltage enable signal is enabled, the voltage output unit outputs the pumping voltage as the second internal voltage.

14. The internal voltage generating apparatus of claim 13,
wherein the voltage output unit comprises:
a first output section configured to output the pumping voltage as the first internal voltage in response to the first voltage enable signal; and
a second output section configured to output the pumping voltage as the second internal voltage in response to the second voltage enable signal.

15. An internal voltage generating apparatus for a semiconductor integrated circuit, the apparatus comprising:
a first voltage detecting unit configured to detect whether a first internal voltage exceeds a first reference level to output a first voltage enable signal;
a second voltage detecting unit configured to detect whether a second internal voltage exceeds a second reference level to output a second voltage enable signal;
a signal combining unit configured to make a voltage pump operate when at least one of the first voltage enable signal and the second voltage enable signal is enabled; and
a voltage output unit configured to output a pumping voltage output from the voltage pump as the first internal voltage or the second internal voltage in response to whether the first voltage enable signal or the second voltage enable signal has been enabled or not.

16. The internal voltage generating apparatus of claim 15,
wherein the signal combining unit is composed of a NAND gate receiving the first voltage enable signal and the second voltage enable signal and an inverter.

17. The internal voltage generating apparatus of claim 15,
wherein the voltage output unit comprises:
a first output section configured to output the pumping voltage as the first internal voltage in response to the first voltage enable signal; and
a second output section configured to output the pumping voltage as the second internal voltage in response to the second voltage enable signal.

18. An internal voltage generating method for a semiconductor integrated circuit, the method comprising:
detecting whether each of a plurality of internal voltages exceeds a corresponding reference level thereby outputting a plurality of voltage enable signals;
generating a pump enable signal in response to the plurality of voltage enable signals;
performing a voltage pumping operation in response to input of the pump enable signal so as to generate a pumping voltage; and
receiving the pumping voltage and outputting the plurality of internal voltages corresponding to the plurality of voltage enable signals, respectively.

19. The internal voltage generating method of claim 18,
wherein the plurality of internal voltages comprise a first internal voltage and a second internal voltage; and
the plurality of voltage enable signals comprise a first voltage enable signal and a second voltage enable signal.

20. The internal voltage generating method of claim 19,
wherein the outputting of the plurality of voltage enable signals enables the first voltage enable signal according to comparing result between a level of the first internal voltage and a first reference level, and disables the second voltage enable signal according to comparing result between a level of the second internal voltage and a second reference level.

21. The internal voltage generating method of claim 19,
wherein the first internal voltage is a bulk voltage; and
the second internal voltage is a voltage having a level lower than that of the bulk voltage.

22. The internal voltage generating method of claim 19,
wherein the first internal voltage is a bootstrapping voltage; and
the second internal voltage is a voltage having a level higher than that of the bootstrapping voltage.

23. The internal voltage generating method of claim 20,
wherein the generating of the pumping voltage comprises:
enabling a pulse enable signal when at least one of the first voltage enable signal and the second voltage enable signal is enabled; and
generating the pump enable signal in response to the pulse enable signal.

24. The internal voltage generating method of claim 20,
wherein, in the receiving of the pumping voltage and the outputting of the plurality of internal voltages, when the first voltage enable signal is enabled, the pumping voltage is output as the first internal voltage, and when the second voltage enable signal is enabled, the pumping voltage is output as the second internal voltage.
